(19) United States
(12) Patent Application Publication
(10) Pub. No.: US 2012/0272530 A1
(43) Pub. Date: Nov. 1, 2012

(54) MULTI-EDGE CHISEL

(75) Inventor: Jared W. Hanlon, Santa Clarita, CA (US)

(73) Assignee: PULL'R HOLDING COMPANY, LLC, Elk Grove Village, IL (US)

(21) Appl. No.: 13/350,754

(22) Filed: Jan. 14, 2012

Related U.S. Application Data
(60) Provisional application No. 61/481,006, filed on Apr. 29, 2011.

(51) Int. Cl. B25D 3/00; B21K 11/00

(52) U.S. Cl. 30/167.1; 76/104.1

(57) ABSTRACT

A multi-edge chisel which can be operated in a hands-free manner is made from a unitary main body with at least one opening. The main body has a flat profile, with a blade on one end, and at least one striking plate on the opposite end.

### CROSS REFERENCE TO RELATED APPLICATIONS

This application claims the benefit as a utility of U.S. Provisional Application No. 61/481,006 filed on Apr. 29, 2011, currently pending.

### TECHNICAL FIELD

The present disclosure relates generally to cutting implements, and, more particularly, to a chisel having multiple cutting edges, and multiple strike locations.

### BACKGROUND OF THE INVENTION

Cutting implements, such as straight chisels, have been employed in the manual trades for many years. These cutting implements allow the user to chip or chisel away at a work surface or other material. Chisels are designed to be impacted by a striking implement, such as the head of a hammer. The striking imparts force on the chisel. Accordingly, chisels have been designed so as to convey the force from the striking implement to the blade.

Chisels have drawbacks and suffer from many disadvantages. While the chisel is designed to convey striking force to the blade, the chisel must be held in place concurrently while being struck. Therefore, the holder's hand experiences at least some of the striking force being applied to the blade. Further, the hand holding the chisel is subject to risk of injury should a mis-strike occur. This risk increases as the heft of the striking hammer increases.

Traditional chisels convey striking force directly to a single blade. The absence of more than one striking surface prevents the user of traditional chisels from changing the nature of the cut.

The blade of many traditional chisels do not significantly exceed the width of the striking surface or the diameter of the shank of the chisel. Given that the handle must be encompassed by the average hand, the resulting chisel blade is of a limited width.

Thus, it is clear that there is an unmet need for a cutting implement, namely a chisel, that protects the users' hand from mis-strikes, that can be used in a hands-free manner of operation and also employs a blade having a wide width.

### BRIEF SUMMARY OF THE INVENTION

Briefly described, in an exemplary embodiment, the chisel of the present disclosure overcomes the above-mentioned disadvantages and meets the recognized need for such improved device.

An object of the invention is to provide a chisel, which when used, facilitates protection of the user's hands, specifically the hand holding the chisel in place while the chisel is struck with a striking instrument. A feature of the invention is the striking surface is surrounded by cross guards which extend laterally at angles from the direction of the impact force. An advantage of these guards is that they redirect mis-strikes to the impact surface of the chisel. An advantage of the invention is that it prevents injury to the hands of the user even if a complete mis-strike occurs.

Another object of the invention is to provide a chisel which allows hands-free operation of the chisel. A feature of the invention is that the aforementioned cross guards provide a means for elevating an impact end of the chisel on a support surface such that the impact end is higher than the blade end of the chisel. An advantage of the invention is that the chisel can be struck at its impact end without the requirement that the chisel be stabilized by a user's hands.

Yet another object of the invention is to provide a chisel having different cutting surfaces. A feature of the invention is that it includes multiple striking plates and therefore positions, with each striking position correlating to at least one corresponding chiseling blade. An advantage of the invention is that the type of cut performed by the chisel may be varied by the use of a different striking position.

Another object of the invention is to minimize shock to the hand holding the chisel. A feature of the invention is that the chisel is held in a variety of positions, off center of the direct path of force exerted by the striking tool. Another feature of the invention is that it allows multiple positions of hands when using the chisel in conjunction with a striking tool. An advantage of the invention is that the hand of the user does not experience the force applied to the tool by the striking tool.

An object of this invention is to create a surface on the chisel to convey information. A feature of the chisel is that in one embodiment, the chisel defines a substantially flat surface, where product information may be conveyed to the end user of the device. Another feature is that the chisel is adapted to receive a leveling indicator, in one embodiment of which is integrally molded with the handle of the chisel. An advantage of the invention is that multiple pieces of information may be related to the user through various means of printing, etching, or embedding on the designated surface of the tool.

Still another object of the invention is to create a durable chisel. A feature of the invention is that it comprises a high-strength inner core, which is encapsulated or integrally molded by impact resistant plastic. An advantage of the invention is that due to the use of plastic cover, the core component remains protected during use. Another advantage of the invention is that the encapsulation of the inner core provides thermal and electrical insulation.

The invention provides a chiseling device comprising a unitary main body having a striking end and a blade end wherein the unitary main body defines at least one aperture between the striking end and the blade end wherein said unitary main body has a substantially flat profile; a blade extending from the blade end of the unitary body; at least one striking plate defined in the striking end of the unitary body; wherein said striking end is on the opposite side of the blade end of the unitary body and wherein the at least one aperture spans the main body between the striking end and the blade end.

The invention also provides a method of manufacturing a multi-edge chisel device comprising: casting from a metallic core, a unitary main body having a striking end and a blade end wherein the unitary main body defines at least one aperture between the striking end and the blade end wherein said unitary main body has a substantially flat profile; forming a blade wherein said blade extends from the blade end of the unitary body; adding at least one striking plate defined in the striking end of the unitary body; covering the main body in an encapsulating material, wherein said encapsulating material extends from the striking end to the blade end, but does not extend onto the blade; wherein said striking end is on the opposite side of the blade end of the unitary body and wherein the at least one aperture spans the main body between the striking end and the blade end.

These and other features and advantages of the marketing device of the present disclosure will become more apparent to those ordinarily skilled in the art after reading the following Detailed Description of the Invention and Claims in light of the accompanying drawing Figures.

### BRIEF DESCRIPTION OF THE DRAWINGS

Accordingly, the present disclosure will be understood best through consideration of, and with reference to, the following drawings, viewed in conjunction with the Detailed Description of the Invention referring thereto, in which like reference numbers throughout the various drawings designate like structure, and in which:

FIG. 1 is a perspective view of one embodiment according to the present disclosure;

FIG. 2 is a profile view of the blade end of the invention, taken along lines 2-2 of FIG. 1;

FIG. 3 is a schematic view of one embodiment of the invention; and

FIG. 4 is a schematic view of the forces hitting the striking plates in the one embodiment of the present invention.

It is to be noted that the drawings presented are intended solely for the purpose of illustration and that they are, therefore, neither desired nor intended to limit the scope of the disclosure to any or all of the exact details of construction shown, except insofar as they may be deemed essential to the claimed invention.

### DETAILED DESCRIPTION OF THE INVENTION

In describing exemplary embodiments of the marketing device of the present disclosure illustrated in the drawings, specific terminology is employed for the sake of clarity. The claimed invention, however, is not intended to be limited to the specific terminology so selected, and it is to be understood that each specific element includes all technical equivalents that operate in a similar manner to accomplish a similar purpose.

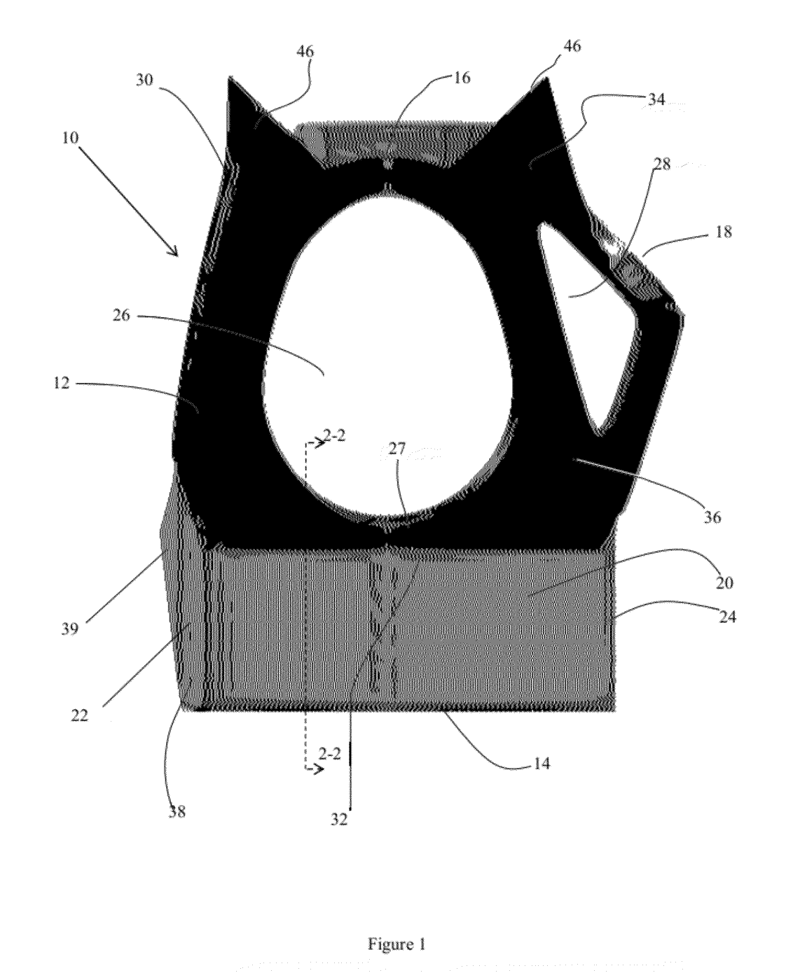

An embodiment of the multi-edge chisel is shown in FIG. 1 designated as numeral 10. As depicted therein, the multi-edge chisel 10 comprises a substantially flat body 12 such that at least a surface of the body is either co-planar to, or parallel to, the plane defined by a blade 20 of the chisel. The body 12 can be made out of any strike-resistant, non-deformable material. In the embodiment shown in FIG. 1, the body 12 incorporates a metallic core encapsulated by a strike resistant plastic encapsulation layer 36.

In one embodiment, the device 10 is manufactured by first casting the main body 12 metallic core, then cooling the core, and finally adding the encapsulation layer 36 using a process of injection molding. In other embodiments, the encapsulation 36 is applied to the core 12 through a process of painting, sputtering or otherwise depositing a layer of encapsulation material. In further embodiments, the encapsulation 36 is added to the metallic core by attaching a pre-cast plastic structure.

The encapsulation layer 36 increases the durability of the device 10, as well as its handling characteristics and performance. The encapsulation layer 36 provides a means to insulate the end user of the device 10 from the inner metallic core. This insulation acts to remediate any temperature differential between the inner metallic core and the user's hands. Further, the encapsulation layer aids to also provide electrical insulation between the metallic core and the end user's hands, a feature useful where the chisel 10 is being used in environments with hidden electrical hazards. As such, in an embodiment of the invention, the layer 36 comprises an electrically nonconductive material, such as rubber, wood, plastic, a combination of plastic and rubber, plastic can be made out of any number of materials such as ABS, PP, PVC, HDPE, and combinations thereof. In the embodiment shown in FIG. 1, during use or operation of the device 10, the users' hands do not contact the inner metallic core or the blade directly, instead always holding the device by holding the encapsulation layer 36 such that the encapsulation layer is positioned intermediate the hand of the user and the body 12 of the chisel.

The main body 12 has a substantially flat profile. In one embodiment, the main body 12 maximum thickness at an impact or striking end 34 end of the body 12 described below), is about twice the thickness of a blade end 32. In one embodiment, the impact end 34 has a 2 inch thickness, as measured perpendicular to the line defining the blade, compared to less than a one inch thickness for the blade end. The flat profile of the main body 12 allows the main body 12 to define at least one substantially flat area 30. Such flat areas are suitable for conveying information, such as the brand name of the chisel, safety information, the date of manufacture, or the type of chisel blade used in the particular embodiment of the chisel. The embodiment shown in FIG. 1 contains one substantially flat area which is used to convey the chisel model and brand information.

The main body 12 also defines two opposing ends, a blade end 32 and a primary striking end 34, the latter of which may contain a plurality of striking surfaces. In the embodiment shown in FIG. 1, the blade end 32 is on the opposing side of the main body 12 as compared with the primary striking end 34.

In the embodiment shown in FIG. 1, the encapsulation layer 36 terminates superior from the at the blade end 32, thereby exposing planar regions of the blade 20. A depending end of this planar region 20 terminates in a blade edge 14.

A blade 20 extends from the encapsulation layer. In one embodiment, the blade 20 is integrally molded with its edge 14. In another embodiment, the blade 20 is removably attached to the blade end 32. The blade 20 is securely attached through attachment means such as screws, pegs, or the like which extend transversely through the encapsulation substrate 36 positioned coplanarly with a first side of the blade 20, transversely through the blade, and then through a second encapsulation substrate positioned coplanary with a second side of the blade 20. The blade 20 must be securely affixed, and so in the removable blade embodiment, the blade 20 is secured by at least two screws, attached directly to the metallic core of the main body 12. The screws are attached along the width of the blade end 32.

In other embodiments, such as the embodiment depicted in FIG. 1, the blade 20 is integrally molded with the metallic 12 of the chisel 10 such that the impact end 16, the blade edge 14, and the body 12 are part of the same single substrate. As shown in FIG. 1, in the embodiment where the blade is an extension of the metallic core, the blade 20 extends from the same metallic core of the main body 12 and comprises the same type of material as the metallic core. In other embodiments, the blade 20 is coated with a metallic layer separate from the core of the main body 12, and also separate from the core of the blade 20.

In embodiments where the blade 20 is an extension of the metallic core, the blade may be re-sharpened whenever it becomes dull. In the embodiment where the blade 20 is formed from the metallic core, but still includes an additional coating layer, the blade may be re-sharpened until the coating layer is exhausted. In embodiments where the blade 20 is removably attached to the main body 12, the blade 20 is replaced when it becomes dull.

In one embodiment, the blade 20 extends the width of the blade end 32. In other embodiments, the blade 20 extends beyond the width of the blade end 32. Given the substantially flat profile of the main body 12, the blade 20 width is capable of reaching high width amounts such as seven inches in width. In one embodiment, the blade 20 is approximately five inches wide. In other embodiments, the blade 20 exceeds five inches.

However, a high width is not optimal for all applications. Therefore the blade 20 includes more than one cutting edge. The primary cutting edge 14 is defined along the width of the blade 20. A secondary cutting edge 22 is defined at a straight edge substantially perpendicular to the primary cutting edge 14. The secondary cutting edge 22 is approximately one third the width of the primary cutting edge 14. This plurality of cutting edges allowing the single chisel 10 to be used for any number of cutting or chipping tasks which require different cutting edge lengths and bevels.

In order to impart a striking force on the secondary cutting edge 22, the opposing side of the blade 20 defines a blade striking area 24. In one embodiment of a single chisel, the secondary cutting edge 22 defines several distinct angled surfaces so that strikes may be accomplished from varying angles. In the embodiment shown in FIG. 1, the secondary cutting edge defines three striking surfaces. The combination of the three angled surfaces forms a conical structure at the secondary cutting edge 22. The first striking surface 38 begins at the blade 20 and ends at the second striking surface 39. The first cutting surface 38 is angled at an obtuse angle in reference to the plane formed by the blade 20. The second cutting surface 39 and defines a cure which extends from the first cutting area 38 to the cutting area (not visible in FIG. 1). The second striking surface joins the first striking area 38 and third striking area at a nearly 90-degree angle. The combination of the three striking surfaces defines a closed polygonal shape defining the blade striking area 24 which extends from the blade 20.

Further, the main body 12 defines at least one transverse extending aperture. In the embodiment shown in FIG. 1, the main body defines two apertures 26, 28. In the embodiment shown in FIG. 1, the second aperture 28 is smaller than the first 26 and situated along the periphery of the first aperture at approximately the 3 o'clock position. While other shapes of the apertures are possible, in the embodiment shown in FIG. 1, the first aperture 26 has an ellipsoidal shape, while the second aperture 28 has a substantially triangular shape. As defined in the main body 12, the apertures 26, 28 are located between the primary striking end 34 and the blade end 32.

In the embodiment shown in FIG. 1, the first aperture 26 is defined within the main body 12 between the primary striking plate 16 and the blade 20. Any force applied to the primary striking plate 16 will be transmitted by the main body 12 (and the main body 12 metallic core) around the first aperture 26. The first aperture 26 is larger than the second aperture 28 to allow removable mounting to a work surface of the main body 12 during force application. As such, the first aperture is adapted to receive the users hand. During use, in one embodiment, the user's hand is inserted through the first aperture 26 with the fingers wrapping about the periphery of the first aperture 26. Therefore, the first aperture 26 must be sufficiently large to accommodate both the user's hand which may also be donning any protective glove.

An outer periphery of the second aperture 28 defines the second striking plate 18. The plane formed by the top surface of the second striking plate 18 forms an obtuse angle with the plane formed by the top surface of the primary striking plate 16, that angle designated by R. When viewed from the side of the device 10, the top surface of the secondary striking plate 18 is angled while the top surface of the primary striking plate 16 is parallel with the primary blade end 32 of the main body 12.

The angled nature of the secondary striking plate 18 allows the chisel 10 to be used for several different types of chiseling actions. Force applied to the secondary striking plate 18 will be directed to the opposing corner of the blade 20, while force applied to the primary striking plate 16 will be applied to the entire length of the blade 20. Consequently, the two striking plates are used to achieve different types of cuts, all while using the same blade 20.

The primary strike plate 16 is flanked by laterally extending cross guards, or deflection surfaces resembling wings 46. The wings protect the device as well as the end users' hands in the event of a mis-strike of a hammer against the strike plate 16. In one embodiment, the wings 46 comprise the same material as the encapsulation 36. In other embodiments, the wings 46 contain an inner metallic core, akin to the rest of the body 12.

In the embodiment depicted, the wings 46 also extend generally perpendicularly beyond the plane of the substantially flat main body 12. The extension of the wings 46 allows for both increased protection of the users' hands, and also provides support for the device 10, while the device 10 is on its side during application of force. The wings 46 balance the main body 12 such that the main body 12 can remain flat on a work surface, without the user holding the main body 12 with the users' hand. In one embodiment, when the main body 12 is balanced on a surface, a leveling bubble 27, visible on the inside of the aperture, is used to ensure that the main body 12 is at a level position. Instead, the user only needs to apply pressure to maintain the main body 12 in place against the work surface, perhaps by stepping on the planar portion of the encapsulated region of the device. As such, the wings extensions provide a means for keeping a user's boot from slipping off the impact end of the device. Inasmuch as the wings 43 are located on the primary striking end 34, opposite of the blade 20, when the wings 43 are resting against the work surface, the blade 20 is in contact with the work surface. Inasmuch as the extension of the wings is perpendicular from the planar portion of the tool, the impact end of the tool is slightly raised from horizontal, when the tool is resting otherwise flat. This facilitates easier access of the strike surface 16 by a hammer swung from overhead.

Consequently, when force is applied to the primary striking plate 16 or the secondary striking plate 18, the blade will cut or chip into the work surface, even though the user is not actually holding the device 10. In this manner, the device 10 can be used with very heavy striking implements which would otherwise be dangerous to use with a traditional chisel, which uses a narrow shaft that the user must hold while the striking implement impacts the top of the chisel. Furthermore, given that both hands are free, the user may employ a striking tool which requires the use of both hands, such as a sledge hammer. Such heavy striking tools cannot be safely used by a single person employing a standard chisel.

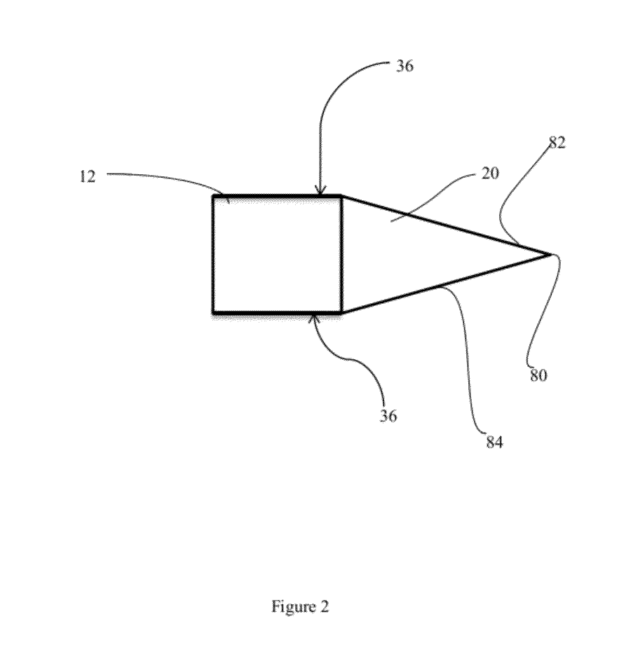

Turning to the profile view of the blade 20 as shown in FIG. 2, the blade 20 emerges from the main body 12 at the blade origin 32. The main body 12 is surrounded by the encapsulation 36. The cutting end 32 of the main body 12 terminates at the cutting edge 14.

The profile of the blade 20 narrows and ends in the cutting edge 14. While in the embodiment shown in FIG. 2, the blade point 80 is a sharpened point, the exact sharpness of the blade point 80 is selected to best fulfill the intended purpose of the chisel 10. In other embodiments, the blade point 80 may not be as sharpened. In yet other embodiments, the blade 20 may terminate in a plurality of sharpened points and other structures as opposed to a single defined blade point 80.

In the embodiment shown in FIG. 2, a first blade side 82 and a second blade side 84 are approximately the same length and shape, forming an isosceles triangle. In other embodiments, the first blade side 82 and the second blade side 84 are of different lengths. Therefore, the profile of the side of the blade 20 forms a scalene triangle. In embodiments having differing blade side lengths, the blade may be rested on one side, resulting in the blade point 80 having a first angle of cutting, and rested on the opposing side with a resulting blade point 80 having a second and different angle of cutting.

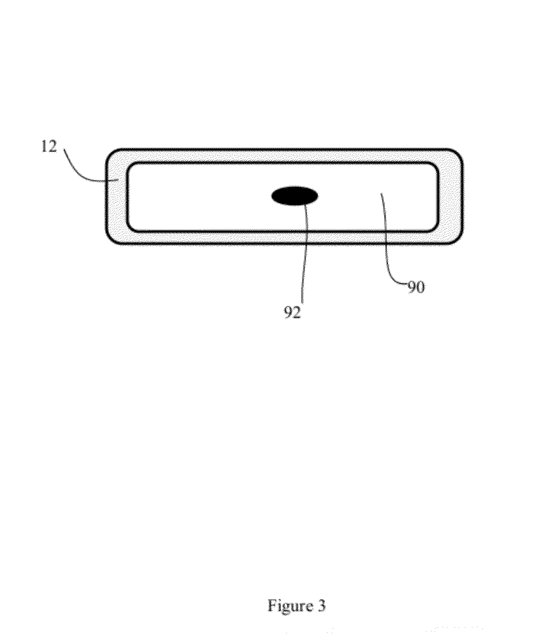

Turning now to FIG. 3, shown therein is a detailed view of the top surface of a striking plate 90. In the embodiment shown in FIG. 1, the striking plates 16, 18 are types of striking plate 90. In one embodiment, both the striking plates 16, 18 are formed in the same manner, and are approximately the same size, but in other embodiments, the primary striking plate 16 is formed using the strike plate template of FIG. 3, while the secondary striking plate 18 is not.

The striking plate main surface 90 is added to the main body 12 before the encapsulation layer 36 is applied. In one embodiment, the striking plate 90 is attached using adhesive, in other embodiments; the striking plate 90 is welded on to the main body 12. In the embodiment shown in FIG. 3, the striking plate defines a central aperture 92, which receives an extension of the main body 12, metallic core. The metallic core extension therefore holds the striking plate 90 in place, especially in conjunction with the encapsulation 36 which is added to envelop the striking plate 90. The encapsulation 36 prevents rotational movement of the striking plate 90 about the metallic core, while the metallic core extension through the central area 92 prevents lateral movement of the strike plate. While in the embodiment shown in FIG. 3, there is only one central area 92 receiving metallic core extensions, in other embodiments, there are multiple such openings spanning the striking plate 90.

As depicted in FIG. 3, the striking plate 90 is substantially rectangular, however, other shapes, such as square and round striking plates are used in other embodiments of the invention.

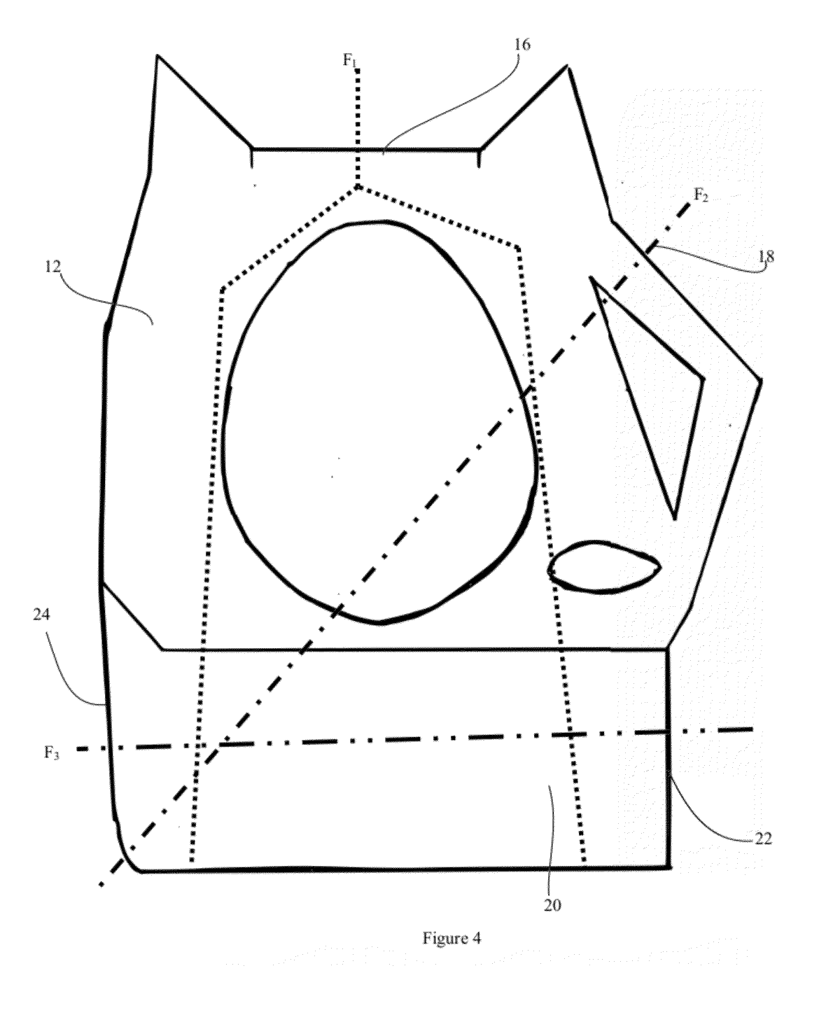

FIG. 4 depicts force application to the device 10. In the perspective view FIG. 1, there are three possible points 16, 18 and 24 to apply three different forces, F₁, F₂, and F₃ respectively Each force may be applied with a striking tool, such as a hammer or the like. Each striking force results in a different type of cutting action by the device 10.

A striking force applied to the primary striking plate 16 is shown as F₁ in FIG. 4. Force F₁ starts at the primary striking plate 16 and traverses the body 12, by traveling around the main aperture 26. In instances where the user is holding the device 10, the fact that the force F₁ is traversing the main body in two parts, traversing the two sides, the hand of the user does not experience the full shock of the force F₁ being applied to the primary striking plate 16. In a conventional chisel, the user's hand is positioned directly between the striking surface and the cutting blade, along the sole path of striking force. Therefore, resulting in increased fatigue for the user. In the embodiment shown in FIG. 4, the force F₁ applied to the main striking plate 16 is divided in two components.

However, the two force F₁ components both end in the blade 20. The presence of the main aperture 26 results in the force F₁ being applied evenly throughout the width of the blade 20.

Force applied to the secondary, or angled, striking plate 18 is depicted as force F₂. An application of striking force to the secondary striking plate 18 results in force F₂ being transmitted from the secondary striking plate 18 to the opposing corner of the blade 20. Therefore, the secondary striking plate 18 is used when a cut or chiseling action is needed in a single point, such as in a tight corner.

Finally, a force F₃ applied to the blade striking area 24 results in a direct force though the blade 20, exiting through the secondary cutting edge 22. The path traveled by force F₃ is such that the main body 12 of the device 10 does not experience any amount of the force F₃. Therefore, a user holding the main body 12 will not be fatigued when the blade striking area 24 is used to apply force against the secondary cutting edge 22.

As depicted in FIG. 4, the device 10 is capable of receiving three different types of forces and each force results in a different type of cut. Force F₁ results in the broad and even cut of the main blade 20. Force F₂ results in a corner cut of only a part of the blade 20. Finally, force F₃ results in the secondary cutting edge being used. Therefore, the single device 10 can be used to chisel three completely different types of cuts, all the while minimizing the amount of fatigue experienced by the user.

### Manufacturing Details

In regards to the construction of the chisel there are two methods in which the main body metallic core can be formed. In one embodiment, the core is forged. The forging process results in a metallic core having a maximum toughness. During the forging process, a crystalline structure forms. The crystalline structure has a tendency to be more intact and therefore result in a stronger composition. In an alternative embodiment, the metallic core of the body of the chisel is to cast it using a lost wax process; this process allows for greater detail but the structure is not as sound as forging.

After the metallic core of the main body is forged or otherwise formed, a number of broaching and milling operations are performed in preparation for installation of the grip. To prepare the chisel edges after the forging or casting operation a coining process may be employed to create a more precise tool. Painting, lacquering, and buffing will be done prior to applying the grip portion of the tool.

After the above operations have been carried out the protective grip is added. There are several alternative embodiments for applying the protective grip. In a first embodiment, process applies a previously injected plastic molded grip that is slightly smaller than the finish or final dimension of the inner core. In one embodiment, the plastic body is made of a single piece. In another embodiment, the plastic body comprises an opposing side A and side B shells that sandwich the metal body and are held together using adhesive or manual fasteners such as screws, and or of clip device. The plastic can be made out of any number of materials such as ABS, PP, PVC, HDPE. After the plastic body has been applied the entire tool, (metal and plastic shell) is placed into a final mold and rubber is injected around the entire plastic body and makes minimal contact with the metal body. This holds everything in place and together. The term rubber is a general and embodiments exist which use TPR, PVC, ABS, or PP for example. In an alternate embodiment, the grip is applied by omitting the plastic shell and comprises the rubberized surface of the metal tool.

Having thus described exemplary embodiments of the present invention, it should be noted by those skilled in the art that within disclosures are exemplary only and that various other alternatives, adaptations, and modifications may be made within the scope and spirit of the present invention. Accordingly, the present invention is not limited to the specific embodiments as illustrated herein, but is only limited by the following claims.

The embodiment of the invention in which an exclusive property or privilege is claimed as follows:

1. A multi-edge chisel device comprising:
a. a unitary main body having a striking end and a blade end wherein the unitary main body defines at least one aperture between the striking end and the blade end wherein said unitary main body has a substantially flat profile;
b. a blade extending from the blade end of the unitary body;
c. at least one striking plate defined in the striking end of the unitary body;
wherein said striking end is on the opposite side of the blade end of the unitary body and wherein the at least one aperture spans the main body between the striking end and the blade end.

2. The multi-edge chisel device as defined in claim 1 wherein said unitary main body comprises a metallic inner core.

3. The multi-edge chisel device as defined in claim 2 wherein said unitary main body further comprises an encapsulating material which covers the metallic inner core up to the blade end of the unitary body.

4. The multi-edge chisel device as defined in claim 1 wherein said blade is removably attached to the unitary main body.

5. The multi-edge chisel device as defined in claim 2 wherein said blade comprises an integral extension of the metallic inner core of the unitary main body.

6. The multi-edge chisel device as defined in claim 6 wherein said blade is covered by an additional metallic substrate.

7. The multi-edge chisel device as defined in claim 1 wherein said blade comprises a substantially rectangular shape having two longer sides and two shorter sides, wherein one longer side is connected to the blade end of the main body and a primary cutting edge is defined against an opposing longer side.

8. The multi-edge chisel device as defined in claim 7 wherein said blade further defines a secondary cutting edge along the width of one shorter side and a blade striking area is defined along an opposing shorter side.

9. The multi-edge chisel device as defined in claim 7 wherein said blade striking area comprises three striking surfaces connected to form a polygonal shape.

10. The multi-edge chisel device as defined in claim 1 further comprising two striking plates wherein a first striking plate is parallel to the striking end and a second striking plate wherein the second striking plate is at an angle to the striking end.

11. The multi-edge chisel device as defined in claim 10 wherein said first striking plate and second striking plate are attached to a metallic core of the chisel and wherein a protrusion of the metallic core of the chisel extends through a central area of the striking plate.

12. The multi-edge chisel device as defined in claim 1 wherein said blade defines a cutting surface comprising a single sharp point.

13. The multi-edge chisel device as defined in claim 1 wherein said blade defines a cutting surface comprising multiple staggered cutting blades.

14. The multi-edge chisel device as defined in claim 7 wherein said blade comprises two equal-length sides.

15. The multi-edge chisel device as defined in claim 7 wherein said blade further two unequal-length sides.

16. The multi-edge chisel device as defined in claim 3 wherein said encapsulation material further defines a plurality of deflection surfaces surrounding said at least one striking plate.

17. The multi-edge chisel device as defined in claim 1 wherein said unitary main body further defines a substantially flat area.

18. A method of manufacturing a multi-edge chisel device comprising:
a. casting from a metallic core, a unitary main body having a striking end and a blade end wherein the unitary main body defines at least one aperture between the striking end and the blade end wherein said unitary main body has a substantially flat profile;
b. forming a blade wherein said blade extends from the blade end of the unitary body;
c. adding at least one striking plate defined in the striking end of the unitary body;
d. covering the main body in an encapsulating material, wherein said encapsulating material extends from the striking end to the blade end, but does not extend onto the blade;
wherein said striking end is on the opposite side of the blade end of the unitary body and wherein the at least one aperture spans the main body between the striking end and the blade end.

19. The method of manufacturing a multi-edge chisel device as defined in claim 18 further comprising sharpening the blade.

20. The method of manufacturing a multi-edge chisel device as defined in claim 18 further comprising covering the blade in an additional metallic compound.
